(19) United States
(12) Patent Application Publication
(10) Pub. No.: US 2005/0100114 A1
(43) Pub. Date: May 12, 2005

(54) System and method for data transmission

(75) Inventors: Ramanujam Satagopan, Singapore (SG); Raja Sundaresan, Germantown, MD (US)

Correspondence Address: OLD DOMINION LAW FIRM, PLLC, 5154 Ballycastle Circle, Alexandria, VA, 22315, US

(73) Assignee: Airbee Wireless, Inc.

(21) Appl. No.: 10/937,894

(22) Filed: Sep. 10, 2004

Related U.S. Application Data
(60) Provisional application No. 60/502,346, filed on Sep. 12, 2003.

(51) Int. Cl. H04L 27/00

(52) U.S. Cl. 375/295

(57) ABSTRACT

Method and system for a power optimal coding scheme used in data transmission. The coding scheme provides for the transmission and reception of asynchronous data using a first in first out driven serial port. In one embodiment of the present invention, preamble and synchronization word patterns are selected such that the start bit of the first byte of data that follows the synchronization word synchronizes with the start bit clocking signal of the baseband receiving serial port. Thereafter, the data stream will be synchronized with the serial port.

### CROSS REFERENCE TO RELATED APPLICATIONS

This U.S. non-provisional patent application claims priority upon U.S. provisional patent application Ser. No. 60/502,346 filed on Sep. 12, 2003 and titled “Power Optimal Coding Scheme for Reception of an Asynchronous Digital Wire Data Stream,” which is incorporated herein by reference.

### FIELD OF THE INVENTION

The present invention relates to a system and method for data transmission. In particular, the present invention relates to a coding scheme for transmission and reception of a data stream using a first in/first out (FIFO) connected universal asynchronous receiver transmitter (UART).

### BACKGROUND OF THE INVENTION

Transmitting data from one place or device to another is an important part of many aspects of life today. Data transmission can be accomplished in many ways including wired and wireless transmission. Wireless transmission involves transmitting data over/through the air without the benefit of a transmission line. However, wireless transmission is subject to various sources of interference requiring a coding scheme for the transmission to insure accurate reception of the transmitted data. In addition, encoding techniques are used to transport digital bits (ones and zeros) of data in carrier waves.

Wireless transmission and reception of data has traditionally been implemented using de-facto coding schemes, such as Manchester coding. Such a transmission/reception (TX/RX) implementation with Manchester coding, for example, utilizes a port pin on a micro-controller for both transmission and reception of data.

Contrary to popular belief, Manchester coding does not represent a one as a high voltage and a zero as a low voltage. In fact, Manchester coding does not use voltage levels to represent bits at all. Manchester coding use voltage transitions to represent bits rather than levels. In this way, the data stream always contains lots of voltage changes and the receiver uses these voltage changes to synchronize its clock to the transmitter's clock.

A zero is represented by a change from a high (positive) to a low (negative) voltage (FIG. 1A) and a one is represented by a change from low to high voltage (FIG. 1B) in the middle of a clock cycle. The combination of ones and zeros of a data stream would thus result in streams of transitions on the port pin of the microcontroller that is eventually transmitted over the air. For example, FIG. 2 shows a data stream of ones and zeros. As can be seen, the sampling point is in the middle of each bit period during the transition. In FIG. 3, the top shows the popular data representation by representing zero as low voltage and one as a high voltage. The lower part shows the same data represented in its actual form using Manchester coding. The diagram shows bit cells as vertical lines and bit sampling time as a carrot (at the center of each bit cell). Changes are allowed at the bit cell boundary, but these are not read as data. They just allow the line to swap levels so that two or more ones or zeros can be sent in a row. The receiver electronics can use the transitions to synchronize its clock provided the receiver can distinguish between half a bit time and a whole bit time.

The use of Manchester coding provides a strong timing component for clock synchronization and recovery because a timing transition always occurs in the middle of every bit. The Manchester line code has the additional property of always maintaining equal amounts of positive and negative voltages. This method prevents the build up of a DC component, which simplifies the implementation of decision thresholds in the data detectors.

Generation of such a data stream of pulses of ones and zeros at the transmitter, and decoding and deciphering the same stream at the baseband of the receiving microcontroller require the use of dedicated timer resources of the microcontroller (dedicated until the completion of transmission or reception) but also utilize the critical horse power of the microcontroller. This reduces the availability of the microcontroller by as much time as it takes to transmit the data or receive when the microcontroller could otherwise be engaged in other tasks or be saving power in a sleep mode. Also, by its nature of coding, Manchester coding halves the data rate due to the representation of two transitions to represent a single ‘bit’ of information (zero or one).

### SUMMARY OF THE INVENTION

The present invention provides a system and method for data transmission using a FIFO connected UART serial port that is easy and more efficient to use and overcomes drawbacks of conventional systems.

In one embodiment of the present invention, the data transmission is coded with a synchronization component that synchronizes the receiver and controls the reception of a payload, and wherein a portion of the synchronization component is selected from a group consisting of C0, E0, and F0.

These and other objects and features of the present invention will become readily apparent from the detailed description, which is to be read in conjunction with the accompanying drawings.

### BRIEF DESCRIPTION OF THE DRAWINGS

FIG. 1A is a diagram depicting a Manchester encoded zero bit.

FIG. 1B is a diagram depicting a Manchester encoded one bit.

FIG. 2 is a diagram depicting a data stream of Manchester encoded bits.

FIG. 3 is a diagram that depicts a conventional representation of a data stream matched with its corresponding Manchester encoded data stream.

FIG. 4 is a coding scheme according to one embodiment of the present invention.

FIG. 5 is a transmission system according to one embodiment of the present invention.

FIG. 6A is a receiving circuit according to one embodiment of the present invention.

FIG. 6B is a shift register interface according to one embodiment of the present invention.

FIG. 7 is a FIFO driven serial port according to one embodiment of the present invention.

FIG. 8 is a transmission according to one embodiment of the present invention.

FIG. 9 is an output according to one embodiment of the present invention.

FIG. 10 is a synch word pattern according to one embodiment of the present invention.

FIG. 11 is a synch word pattern according to one embodiment of the present invention.

FIG. 12 is a coded transmission according to one embodiment of the present invention.

FIG. 13 is a coded transmission according to one embodiment of the present invention.

FIG. 14 is a coded transmission according to one embodiment of the present invention.

FIG. 15 is a coded transmission according to one embodiment of the present invention.

FIG. 16 is a flow chart depicting a coded transmission reception according to one embodiment of the present invention.

FIG. 17 is a preamble synch word table according to one embodiment of the present invention

FIG. 18 is a flow chart depicting data transmission according to one embodiment of the present invention.

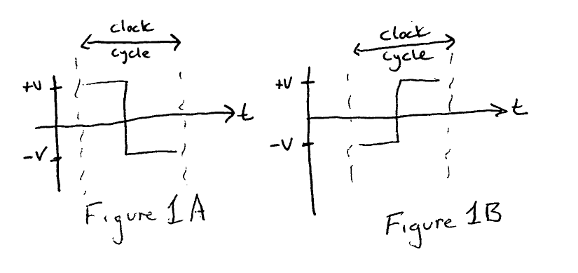

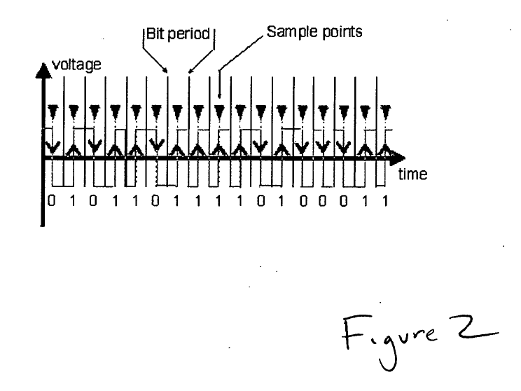

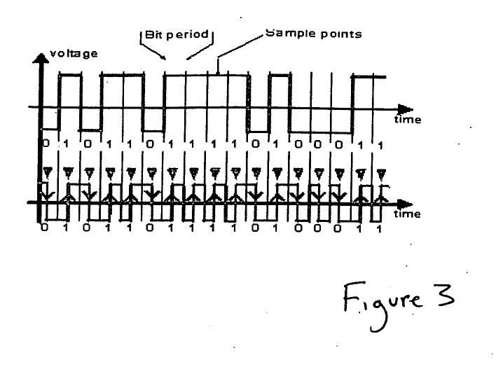

### DESCRIPTION OF THE PREFERRED EMBODIMENT

In the following detailed description, numerous specific details are set forth in order to provide a thorough understanding of the present invention. It will be apparent to one of ordinary skill in the art however, that these specific details need not be used to practice the present invention. In other instances, well known structures, interfaces and processes have not been shown in detail in order not to unnecessarily obscure the present invention.

One embodiment of the present invention relates to a specific coding scheme to achieve wireless transmission of a data stream using a FIFO connected UART serial port and for reception using a universal standard serial port with or without a FIFO attached. This embodiment allows for data transmission and reception by effectively relieving the microcontroller of its expenditure of horse power by utilizing the inherent “parallel processing” architecture of the serial port circuitry within a microcontroller.

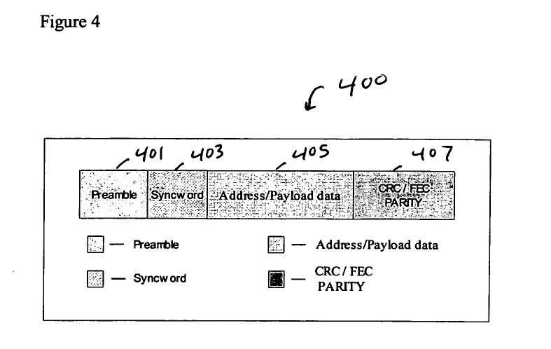

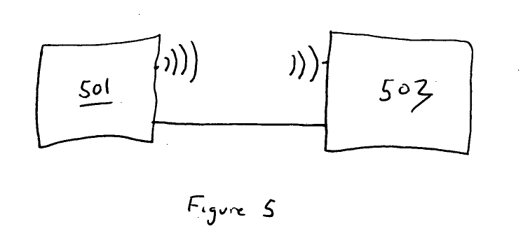

A typical wireless data transmission protocol 400 is shown in FIG. 4. The protocol can include a preamble 401, synchronization word (sync word) 403, address/payload data 405 and cyclic redundancy check/forward error correction/parity (CRC/FEC/Parity) 407.

The preamble 401 is a continuous transition of ones (1) and zeros (0)—101010—sent at a constant frequency. The decoder (receiver) uses the preamble 401 to determine if the data received is a valid signal. The preamble 401 does a primary synchronization of the receiver with the data stream. The decoder starts a clock timer when it senses the first few bits of the incoming preamble 401 at the constant frequency. The frequency of the clock timer is the same as the frequency of the preamble 401. Synchronization of the decoder's clock with the preamble 401 is asserted when the decoder ascertains a definitive number of preamble 401 bit pattern transitions (which is a known count) to ensure that the preamble 401 signal received was not due to a random noise. This synchronization simply assures the receiver and the decoder that there is a valid data packet to be received at the end of the preamble 401 and the sync word. The receiver therefore continues to keep receiving further data bits. In the event that the receiver and decoder receive a miscorrelated set of preamble 401 bits within the required number of preamble 401 transitioning bits being received, they disqualify the preamble 401, stop receiving and processing any further bits in the current stream and await the advent of the next initial set of preamble 401 bits. The preamble 401 is usually a long pattern that is long enough to cover for the potential sleep duration of the target receiver.

The Sync word 403 is typically an identifier code that serves as a secondary and critical code to synchronize the receiver with the data stream. The receiver correlates the sync word 403 (compares the sync word with a known pattern) and gets ready for decoding and deciphering of data that immediately follows the sync word 403. The sync word 403 immediately follows the preamble at the same frequency as that of the preamble. While the receiver passes the sync word 403 to the decoder following the preamble, the decoder performs a bit by bit sliding correlation between the data bits of the sync word 403 that are received immediately following the last bit of the preamble and the known code pattern that it would have stored in its memory. When correlated, the receiver and decoder enter a state where they can start receiving the data bits pertaining to the Address/Payload Data 405 packet. If correlation fails, the receiver and decoder stop receiving and processing any further bits in the current stream and await the advent of the next initial set of preamble 401 bits.

The Address/Payload Data 405 is a packet containing the data of. importance: This packet 405 could, depending on the implementation, contain the address of the intended device, control information and/or payload data.

The CRC/FEC/Parity 407 is an error correction tool. Depending on the implementation, this tool 407 could either be a simple CRC (Cyclic Redundancy Check, error detection) or a parity set for limited error correction, governed by the FEC (Forward Error Correction) scheme employed.

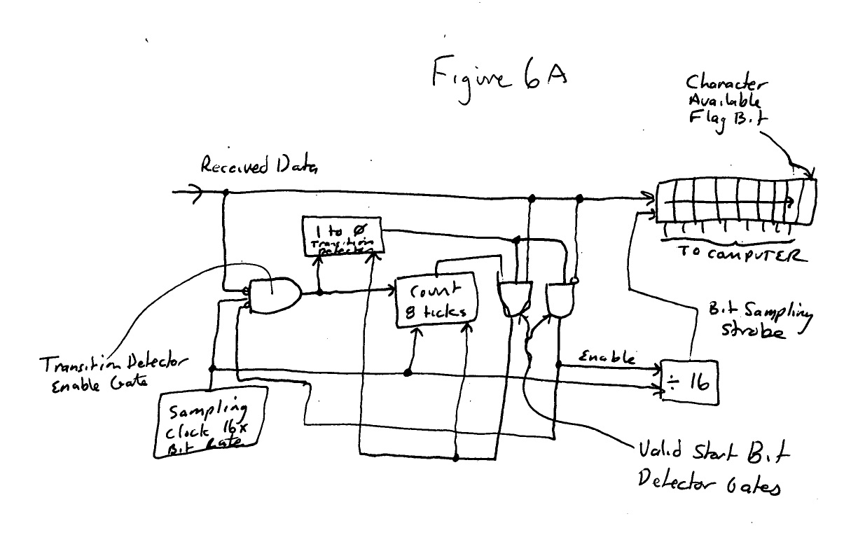

In one example of a transmission system shown in FIG. 5, a first device 501 communicates with a second device 503. The first device 501 and second device 503 can each contain a transceiver for the transmission and reception of data. For example, some devices use a universal asynchronous receiver transmitter (UART) that performs asynchronous communications functions by converting parallel digital output from a data terminal equipment (DTE) into a serial bit transmission and vice versa.

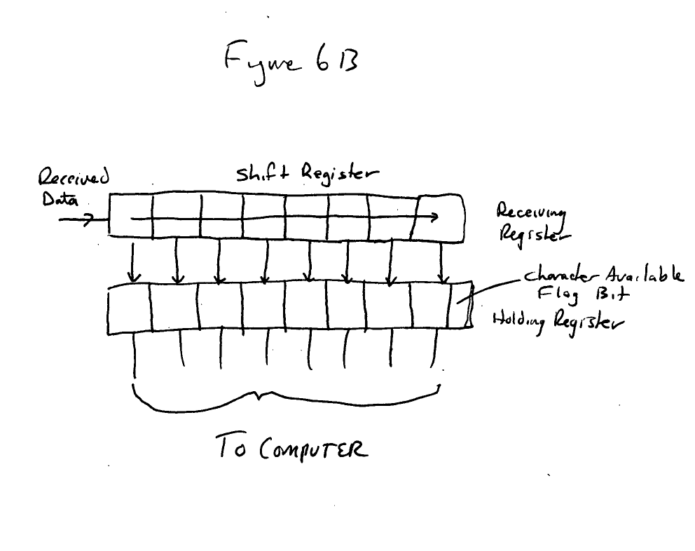

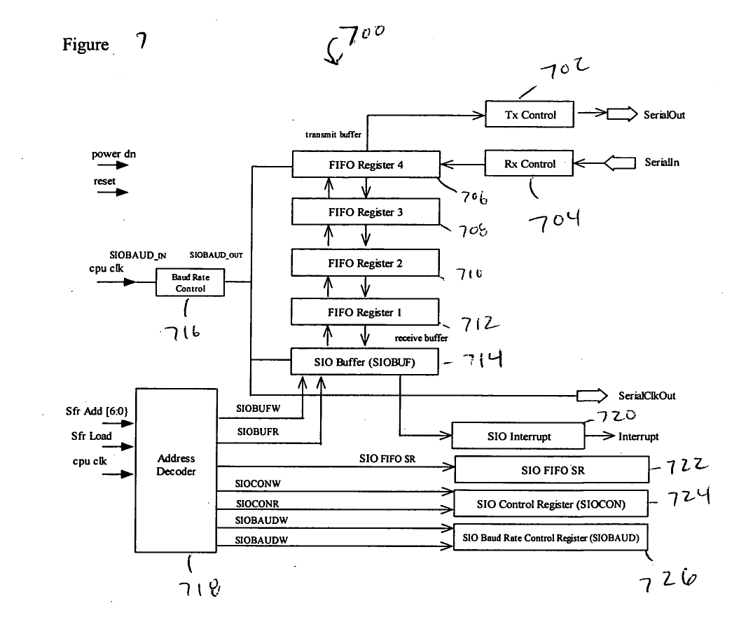

FIG. 6A shows an example circuit for receiving asynchronous serial data in an eight-bit code. It utilizes a clock that runs at 16 times the symbol rate of the incoming data. This rapid rate is used to detect the 1 to 0 transition (when the start bit begins) as soon as possible after it occurs. The circuit that detects the 1 to 0 transition enables a spike detection circuit. Eight “ticks” of the 16× clock (one-half a bit time) are counted, and then the line is checked to see whether it is still in the 0 state. If it is not, it is assumed that the initial 1 to 0 transition was due to noise on the line, the spike detection circuit is reset, and no further action is taken.

If the line is still at 0, a valid start signal has arrived. A counter is enabled that divides the 16× clock by 16 to produce a sampling clock that ticks once per bit time for the shift register. This tick occurs roughly at the center of the bit being sampled. The off-center error can be made smaller by sampling at 32 times the bit rate, and even further reduced by sampling at 64 times the bit rate. However, when higher sampling rates are used, the counter in the spike detection circuit and the counter in the bit sampler circuit must count proportionately higher.

The bit sampler circuit strobes the shift register eight times to sample the state of the line to get the eight bits into the serial to parallel shift register. Then a signal, called a flag, is sent to the computer or controller with which it is associated to announce that a character has been received. The computer than signals the shift register to transfer the eight bits in parallel into the processing circuits.

A problem with using only a shift register (called a single-buffered interface) is that when characters are arriving continuously, the computer has only the duration of the stop bit to read the received character before the next character begins entering the register. A simple improvement is to provide a holding register into which the received character can be parallel transferred as soon as the eighth bit has been sampled. A character-available flag is sent to the computer when the parallel transfer occurs, and the receiving register becomes available for the next character. This arrangement, called a double-buffered interface, is shown in FIG. 6B. In either case, the arrival of a character that cannot be handled because the preceding character has not been read is called data overflow. If overflow occurs, most receiver circuits overwrite the old character with the new one (the old one is lost) and place and error signal on a separate lead to the computer.

The electronic circuitry previously described has been reduced through the use of very large scale integrated circuitry onto a communications chip referred to as a UART. The UART in its transmit mode converts the bits received in parallel, which represent a character within a computer, into a serial data stream and then transfers each bit onto the serial interface at an appropriate time. In addition, the UART frames the character to include the addition of start and stop bits and optionally add a parity bit before transmitting the bits in a serial sequence. When in its receive mode, the UART samples the line for incoming bits; forms a stream of bits into a character after removing the start, stop, and parity bits; and transfers the received character to the computer.

Through the use of UARTs that are no bigger than a thumbnail, it becomes possible to provide every type of personal computing device, ranging in size from a desktop to a personal digital assistant or cellular phone, with a serial port.

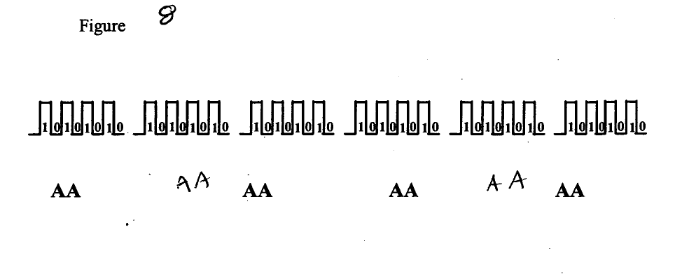

FIG. 7 depicts one embodiment of a FIFO driven serial port. In this embodiment, the preamble is passed through the FIFO connected to the transmit UART, and a “selected” sync word pattern, followed by the address and data.

The serial port 700 may include a transmission control 702 for outputting serial data and a reception control 704 for inputting serial data. The port 700 may also include a plurality of FIFO registers 706, 708, 710, and 712, a SIO buffer 714, a baud rate control 716 the inputs a cpu clock signal to control the reception and transmission rate, an address decoder 718, a SIO interrupt 720, a SIO FIFO register 722, a SIO Control Register 724, and a SIO baud rate control register 726. The serial port interface 700 can be configured either as transmit or receive data (half-duplex) buffers. Transmission is initiated by placing data bytes into the FIFO registers 706, 708, 710 and 712 through the serial buffer 714. Reception is initiated when data bytes are received in the FIFO buffer. The serial port interface 700 ensures gapless and continuous wireless data transmission. In the conventional serial port operation, the processor receives an interrupt for every byte of data received or transmitted. In contrast, in the FIFO based serial port 700 operation the processor receives an interrupt only for every four or three bytes of data transmission or reception resulting in increased availability of processor time.

In another embodiment, the preamble and the sync word patterns are selected such that the start bit of the first byte of data that follows the sync word, always synchronizes with the start bit clocking signal of the baseband received serial port. From there on, the data stream will be in sync with the serial port.

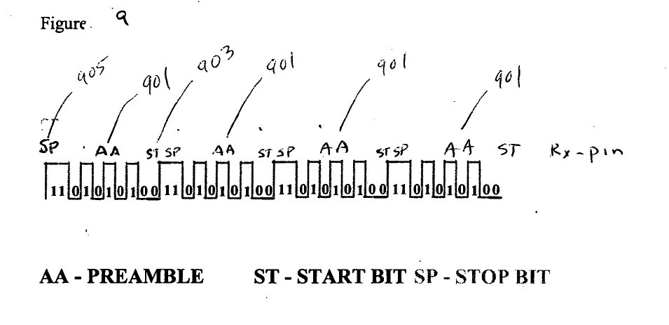

A typical preamble is shown in FIG. 8. It is a continuous stream of alternating zeros (0) and ones (1). This pattern not only simplifies detection of the signal on the air, but also appears as a stable signal to the receiver (making the DC offset of the signals associated with longer zeros (0) and ones (1) cancel each other). The eight bit word pattern is shown as repeating AA (hexadecimal).

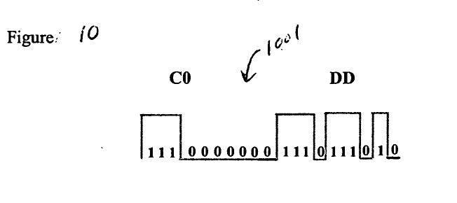

FIG. 9 shows one embodiment of a UART output including a preamble 901 modified by a serial port. In FIG. 9, a preamble 901 (“AA-10101010”) is used. However, since we use the FIFO-UART for transmission, START (ST) 903 and STOP (SP) 905 bits are inserted every 8 bits of the data byte that passes by the UART. The output pattern is shown in FIG. 9. The start bit START (ST) 903, which is a bit of logic level 0 or LOW, is stuffed prior the LSB of the preamble 901 byte (“AA-10101010”) and the STOP (SP) 905 bit which is a bit of logic level 1 or HIGH, is appended to the MSP of the preamble 901 byte (“AA-110101010”), before transmission. The sequence of the bits transmitted are as follows: START (ST) 903 first, followed by LSB of preamble 901 byte (“AA-10101010”) followed by the remaining 7 bits of the preamble 901 data byte and then followed by STOP(SP) 905 bit. The FIFO-UART transmits all these bits at a uniform clock rate. At the same clock rate, this pattern is immediately followed by the transmission of the START (ST) 903 bit of the second byte in the FIFO buffer and the sequence of transmission follows until all the FIFO bytes are transmitted out.

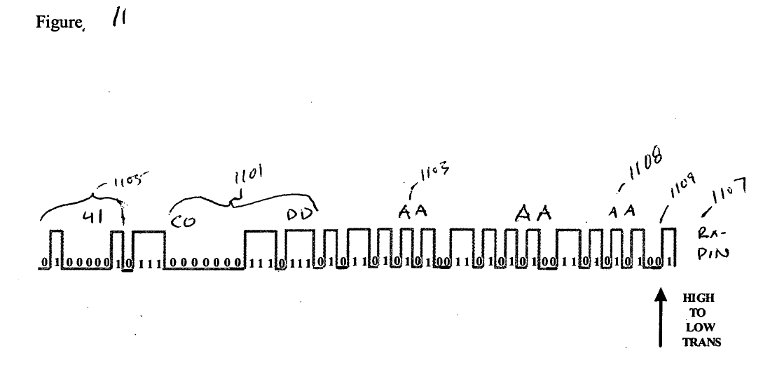

FIG. 10 shows one embodiment of a Sync Word pattern (“C0-1100 0000 and DD-1101 1101 bit pattern) 1001. Once the preamble 901 data bytes are transmitted sequentially through the FIFO, the sync word pattern is placed in the FIFO registers as two bytes, DD-1101 1101 first followed by C0-1100 0000 and the Sync Word pattern will be transmitted in the same manner as the preamble bytes.

The sync word 1001 in this embodiment is C0 DD (C0DD is a hexadecimal word, where DD is the lower byte and C0 is upper byte). The bit pattern of the sync word is shown in FIG. 10. Note the start and stop bits in the word pattern.

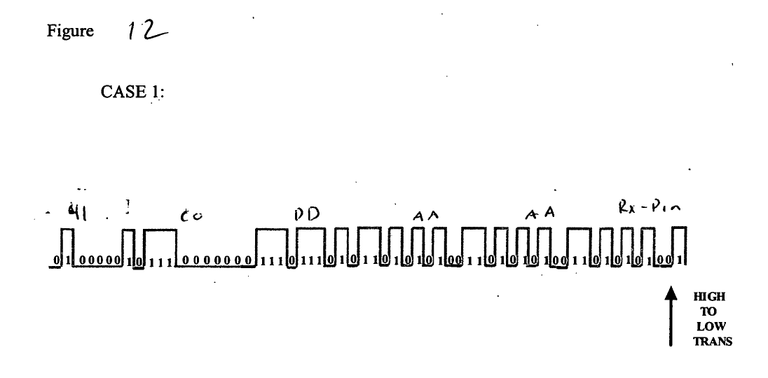

In another embodiment, the sync word 1101 along with the preamble 1103 and a sample data 1105 (0×41) is shown in FIG. 11. The status of the serial receiver pin (Rx-pin) 1107 is normally in a high state. The low to high transition when the START bit 1109 is received, enables the UART to detect the start bit 1109, which is always zero. Reception is initiated by a detected 1-to-0 transition at the serial receiver pin (Rx-pin) 1107. Upon detecting such a transition, the start bit is assumed to be valid. Then, the serial receiver of the UART will clock in the subsequent 8 bits of the 10-bit byte 1108 at a uniform clock rate and finally the stop bit. This characteristic of the UART receiver, it starts clocking the reception of the incoming byte when subject to a start bit transition from a 1(HIGH) to 0(LOW), allows the system to get an accurate data synchronization. The first of the two data bytes of the Sync Word DD (hex value 1101 1101) provides a cushion effect while breaking the incoming preamble stream 1103 sequence to lead into the recognition of the Sync Word DD 1101 correlation. The second and higher byte of the Sync Word C0 (hex value 1100 0000) 1101 provides for further cushioning through the bit stream of zeroes (all 6 LSBs of the byte C0 are zeroes or LOW bits) until the two most significant bits of the higher byte of the Sync Word C0, which are both high bits (11), set up the UART receiver to a high state. This achieves complete synchronization to a state of readiness such that the start bit of the incoming payload byte (sample 0×41) 1105 triggers the clocking in of the eight (8) further data bits to be received by the UART. Until the uppermost two bits of the byte C0 of the sync word 1101 are received, the baseband UART receiver will inherently reject the bits since there are no high-to-low transitions during the cushion period (period during which the byte C0 is received). Thus, the byte C0 is critical for full synchronization to the data stream during reception by the UART.

Another embodiment provides for the transmission and reception of an asynchronous wireless data stream using a FIFO based serial port. This embodiment will enable the transmission of the data continuously without forming the “gap” between the bytes. Using a UART with FIFO for transmission can ensure uniformity in the frequency of data bits transferred. A gap formed due to usage of a UART without a FIFO, depending on the duration of the gap, due to a long zero (0) or a long one (1) logic level that will prevail through the gap. When received by the receiver, this may cause a DC drift issue at the receiver, potentially causing the average signal level to fall out of the range of the RF receiver's reference voltage detection level and consequentially cause the receiver to miss or malfunction while detecting the RF packet transmitted. This will ensures a continuous transmission of the data stream. During reception, the reception is initiated by a detecting 1-to-0 transition for every byte with respect to the baud rate, which is determined by the internal timer overflow. This allows the system to overcome the drift and synchronization problem that is encountered in Manchester coding.

In previous embodiments, the synchronization bytes are DD C0, where DD is the lower byte (least significant byte—MSB) and C0 is the upper byte (most significant byte—MSB). The sync bytes are appended to the preamble to get synchronized at the start bit of the first data byte.

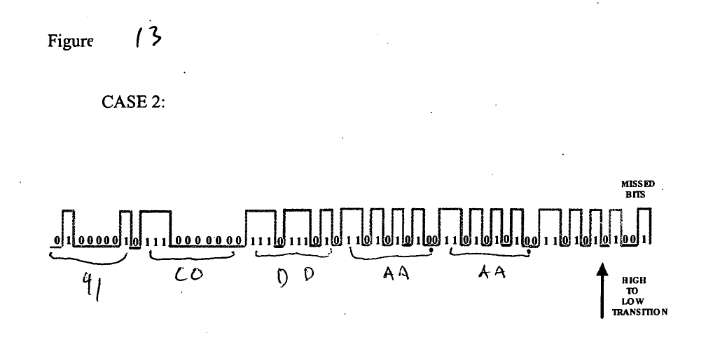

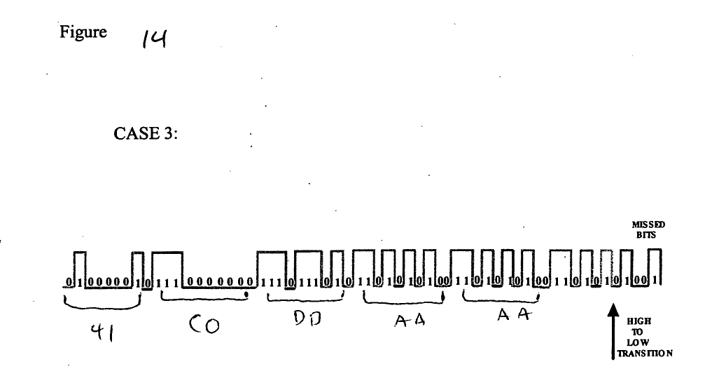

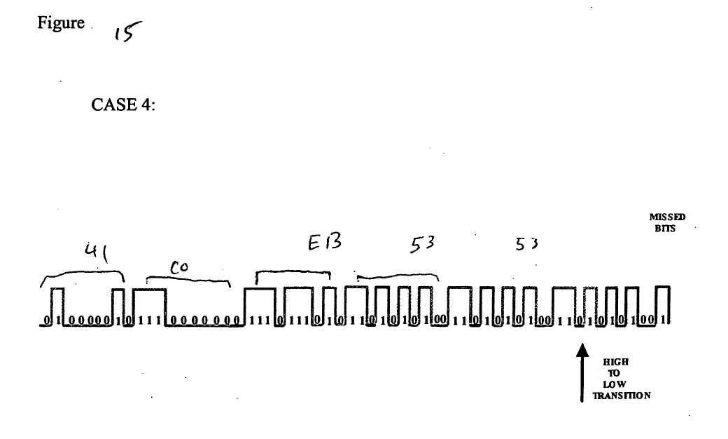

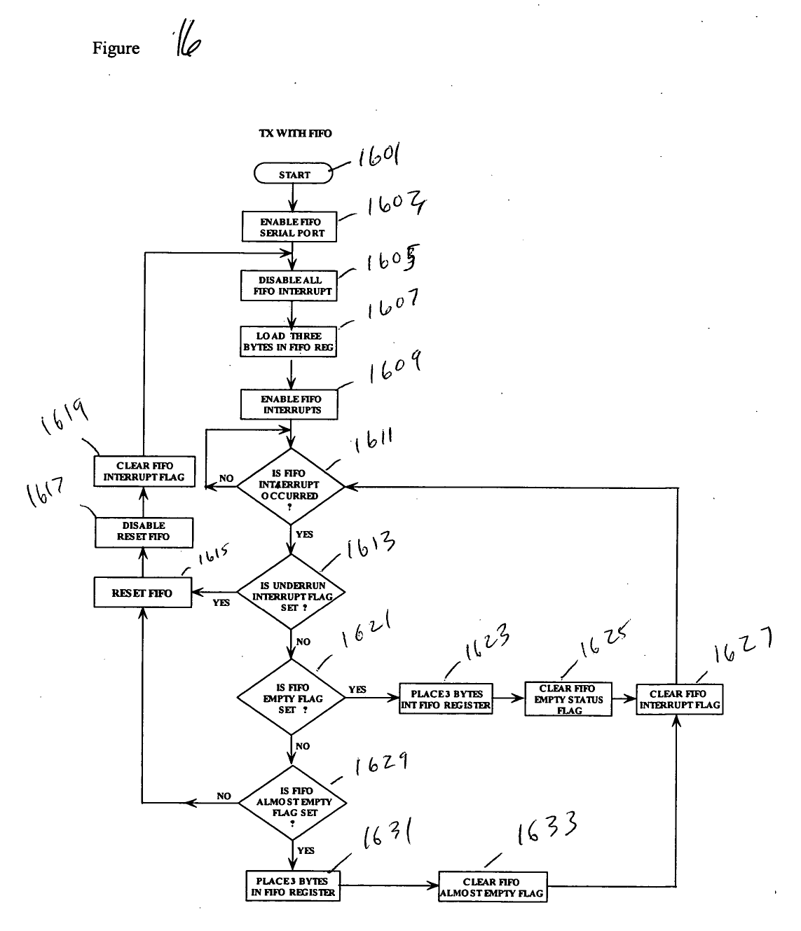

In choosing the sync bytes, the MSB of the sync word is more important than the LSB. The MSB, C0, helps to sync with the start bit of the first data byte without regard to where the receiver starts reading the preamble. The preamble used in this embodiment is AA resulting in four possible patterns for a valid receiver starting sequence, which are shown in FIGS. 12-15. In all four cases the Most Significant Byte C0 will help to sync with the first data byte

The sync bytes serve to synchronize the receiver with the data stream. Other alternative sync words are

E0 DD

F0 DD

In both the above mentioned sync bytes, the upper byte serves to synchronize with the start bit of the first data byte.

The following embodiment show a transmit algorithm using a UART with FIFO. In this embodiment, a microcontroller with an 8051 core having a FIFO driven UART can be used as well as other microcontrollers.

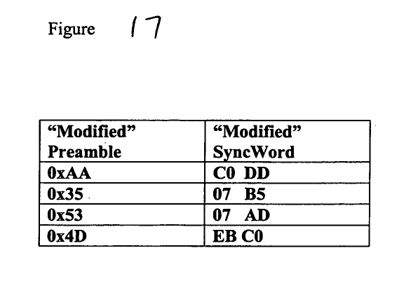

FIG. 16 illustrates one method according to this embodiment for transmitting with a FIFO driven UART. The transmission process is initialized (1601). Then the FIFO serial port is initialized (1603). Next, all FIFO interrupts are disabled (1605).

Then, three bytes are loaded into the first three FIFO registers (1607). After loading the bytes, the FIFO interrupts are enabled. The process then checks to see if a FIFO interrupt occurs (1611). If not, the process keeps checking for an interrupt (1611). If an interrupt occurs, the process checks to see if the underrun interrupt flag has been set (1613).

If the underrun interrupt flag has been set, the process resets the FIFO (1615). Then the reset FIFO is disabled (1617). This is followed by clearing the FIFO interrupt flag (1619). The process then returns to disabling all FIFO interrupts (1605).

If the underrun interrupt flag has not been set, a check is made to see if the FIFO empty flag has been set (1621). If the empty flag has been set, the 3 bytes are place into the FIFO registers (1623). Then, the empty status flag is cleared (1625). Next, the FIFO interrupt flag is cleared (1627). After clearing the interrupt flag, the process repeats checking for interrupts (1611).

If the underrun interrupt flag and the empty flag have not been set, a check is made to see if the FIFO almost empty flag has been set (1629). If the almost empty flag has not been set, the process resets the FIFO (1615). If the almost empty flag has been set, the process places the 3 bytes into the FIFO registers (1631). Then, the process clears the almost empty flag (1633). Next, the process clears the FIFO interrupt flag (1627). After clearing the interrupt flag, the process repeats checking for interrupts (1611). The UART will interrupt either for underflow (1613) or almost empty (1629) or buffer empty (1621) conditions of the transmitter. Placing the bytes in the serial buffer (714), the UART will move the data to the FIFO register (1623) for initiating the next transmission.

By disabling the FIFO EMPTY interrupt, the first four bytes to be transmitted are loaded into the FIFO register. Then ALMOST EMPTY interrupt can be enabled so that the controller will be interrupted after transmitting every three bytes leaving one byte in FIFO. The software will disable almost empty interrupts after loading three more bytes into the FIFO. This ensures a continuous data stream transmission over the air. The flow chart shown in FIG. 16 shows a FIFO driven UART as the baseband output and RF data input.

Another embodiment shows a receive algorithm using a UART with or without FIFO. In this embodiment, the bytes are received through serial interrupt either with FIFO or without FIFO configuration. Once the bytes been received, the bytes have to be compared with either one of the four patterns 0×AA, 0×35, 0×53 or 0×4D for the preamble 0×AA respectively. One of these bytes is what will be received at the UART right after the stream of preambles is received. These bytes are received depending on the position of the preamble at which the UART receiver started processing the incoming data. Any of these four bytes received will be correlated with a “corresponding” sync word.

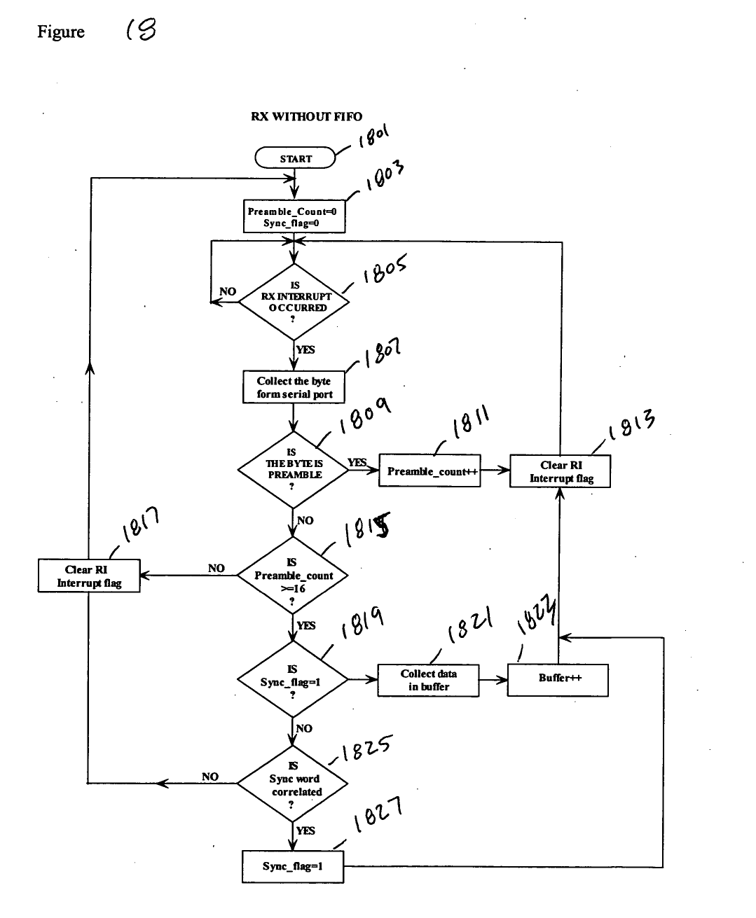

Depending on the bit at which the “modified” preamble was detected, the sync word gets “modified” to one of the pairs shown in FIG. 17. The sync word encountered for the above different patterns are also shown in FIG. 17.

Detection of any of these pairs in software is the point at which the payload data is synchronized. These get filtered in software. In all four patterns, the receiver is synchronized with the data stream. The flow chart in FIG. 18 detects the sync word for the possible combinations discussed.

FIG. 18 shows one embodiment of data transmission without a FIFO. The process is initialized (1801). After initialization, the preamble-count and sync-flag are set to zero (1803). Next, the process checks to see if a reception interrupt has occurred/been detected (1805). If a reception interrupt has not occurred, the process continues to check for interrupts (1805). If a reception interrupt has occurred, the process collects the byte received from the serial port (1807). Then, the process determines if the byte collected is a preamble (1809).

If the byte collected is a preamble, the preamble-count is increased by one (1811). Next, the reception interrupt flag is cleared (1813). Then the process returns to checking for the occurrence of a reception interrupt (1805). If the byte collected is not a preamble, a check is made to see if the preamble-count is greater than or equal to sixteen (1815).

If the preamble-count is not greater than or equal to sixteen, the reception interrupt flag is cleared (1817). Then, the process returns to setting the preamble-count and sync-flag to zero (1803). If the preamble-count is greater than or equal to sixteen, the sync-flag is checked to see if it is equal to one (1819).

If the sync-flag is equal to one, the data is collected in a buffer (1821). Then, the buffer is incremented (1823). Next, the reception interrupt flag is cleared (1813) and the process returns to checking for the occurrence of a reception interrupt (1805).

If the sync-flag is not equal to one, a check is made to see if the sync word is correlated (1825). If the sync word is not correlated, the reception interrupt flag is cleared (1817) and the process returns to setting the preamble-count and sync-flag to zero (1803).

If the sync word is correlated, the sync-flag is set to one (1827). Next, the reception interrupt flag is cleared (1813). Then the process returns to checking for the occurrence of a reception interrupt (1805). The UART will initiate the receive interrupt (1805) either for overflow or almost full or buffer not empty conditions of the receiver. Reading the bytes from the FIFO registers 706, 708, 710 and 712 through the serial buffer 714, sets the UART ready to receive the next data.

Advantages of employing the present method over conventional methods are:

Significant power saving can be achieved at the baseband by utilizing the inherent parallel processing offered by the UART, thus freeing up the baseband controller to perform other tasks in parallel;

Employing this method allows for building higher data rate wireless data applications on low-speed microcontrollers such as those with 8051 core, when otherwise normally require microprocessors and controllers that operate at higher speeds, consequently more expensive than their low-speed counterparts;

In comparison with coding techniques such as Manchester coding, the data rate in this method is much better preserved closer to the intended rate, and the percentage reduction in the effective data rate tends to be much lower; and

In this method, the effective data rate reduces due to the stuffing of 2 bits (the Start and Stop bits) by the UART, every 8 bits of payload data.

In one embodiment of the present method employing a coding sequence and the UART, transmission and reception of longer zeros and ones might cause a DC offset of the RF signal over the air. The DC offset can be addressed in hardware. In such cases where the DC offset is an issue and not addressable in hardware, suitable encryption or bit stuffing techniques can be employed, that would randomize the signal patterns before transmitting over the air.

In the foregoing specification, the invention has been described with reference to specific exemplary embodiments thereof. Many changes or modifications are readily envisioned. The specification and drawings are, accordingly, to be regarded in an illustrative rather than in a restrictive sense. It will, however, be evident that various modifications and changes may be made thereunto without departing from the broader spirit and scope of the invention as set forth in the claims.

1. A method for data transmission using a serial port, the method comprising:
enabling the serial port;
disabling a plurality of interrupts;
loading first data in a register;
enabling the plurality of interrupts;
determining if an interrupt condition is present;
determining if the register contains the first data;
loading second data in the register if the interrupt condition is present and the register does not contain the first data; and
transmitting the second data.

2. The method of claim 1, further comprising enabling a plurality of flags.

3. The method of claim 2, wherein the plurality of flags comprises an interrupt flag, an underrun interrupt flag, an empty flag and an almost empty flag.

4. The method of claim 3, further comprising determining if the underrun interrupt flag is set if the interrupt condition is present; and if the underrun interrupt flag is set, resetting the register, disabling the reset register, and clearing the interrupt flag.

5. The method of claim 4, further comprising determining if the empty flag is set if the interrupt condition is present and the underrun interrupt flag is not set; and if the the empty flag is set, loading the second data in the register, clearing the empty flag, and clearing the interrupt flag.

6. The method of claim 5, further comprising determining if the almost empty flag is set if the interrupt condition is present, the underrun flag is not set, and the empty flag is not set; and if the almost empty flag is set, loading the second data in the register, clearing the almost empty flag, and clearing the interrupt flag.

7. A coding scheme for transmission of a data stream to a receiver, comprising:
generating a preamble;
generating a synchronization component having a first portion and a second portion;
obtaining a payload;
generating an error control; and
transmitting the data stream to the receiver;
wherein the synchronization component synchronizes the receiver and controls the reception of the payload, and the first portion of the synchronization component is selected from a group consisting of C0, E0, and F0.

8. The coding scheme of claim 7, wherein the second portion of the synchronization component is DD.

9. The coding scheme of claim 8, further comprising modifying the synchronization component based on the data stream received by the receiver.

10. The coding scheme of claim 9, further comprising modifying the synchronization component based on the preamble received by the receiver.

11. The coding scheme of claim 7, wherein the first portion of the synchronization component is CO and the second portion of the synchronization component is DD.

12. The coding scheme of claim 11, further comprising modifying the first portion of the synchronization component to one of C0, 07, and EB; and modifying the second portion of the synchronization component to one of DD, B5, AD, and C0.

13. A system for transmitting a data stream according to the coding scheme of claim 7.

14. The system of claim 13, further comprising:
a plurality of registers for storing at least a portion of the data stream;
a rate control component for control the transmission rate of the plurality of registers; and
a transmission control component for transmitting the data stream stored in the plurality of registers.
